(19) United States
(12) Patent Application Publication
(10) Pub. No.: US 2011/0273955 A1
(43) Pub. Date: Nov. 10, 2011

(54) LIQUID MIXING DEVICE

(75) Inventors: Takehiko Matsumura, Yokohama-city (JP); Yoshihiko Uchino, Yokohama-city (JP)

(73) Assignee: NANOMIZER INC., Yokohama-city (JP)

(21) Appl. No.: 13/107,581

(22) Filed: May 13, 2011

Related U.S. Application Data
(63) Continuation of application No. PCT/JP2008/070812, filed on Nov. 14, 2008.

(51) Int. Cl. G05D 11/02; B01F 3/08

(52) U.S. Cl. 366/152.1

(57) ABSTRACT

Provided is a liquid mixing device capable of mixing together two or more kinds of liquids successively in an accurate ratio. The liquid mixing device includes: a first supply system for supplying a first liquid; a second supply system for supplying a second liquid; and a liquid mixing system that receives supply of the first liquid and second liquid from the first supply system and the second supply system, respectively, in which: the first supply system communicates to the liquid mixing system through a first flow rate regulation unit having a first path sectional area; the second supply system is connected to the liquid mixing system through a second flow rate regulation unit having a second path sectional area; and the first liquid in an amount corresponding to the first path sectional area and the second liquid in an amount corresponding to the second path sectional area are allowed to flow into the liquid mixing system, respectively, by making an inside pressure of the liquid mixing system negative.

### CROSS-REFERENCE TO RELATED APPLICATIONS

This application is a continuation of PCT International Application No. PCT/JP2008/070812, filed Nov. 14, 2008, which is incorporated herein by reference in its entirety.

### TECHNICAL FIELD

The present invention relates to an device for mixing together two or more kinds of liquids, and more specifically, to an device for mixing together two or more kinds of liquids in a predetermined mixing ratio.

### BACKGROUND ART

There are cases where a step of mixing together two or more kinds of liquids is carried out in a production, processing, or analysis of products, half-finished products, materials, or specimens in various industrial fields such as chemistry, medicals, food, and semiconductors. When more than a certain degree of accuracy is required for the mixing ratio of the liquids in the above mentioned mixing step, the liquids are often mixed together by a batch method which has excellent weighing accuracy.

However, mixing by the batch method may involve difficulty in realization of an inline process for the production, or the like.

When compatibility between liquids to be mixed together, such as a water-oil based emulsion, is low or when a difference of the mixing ratio between liquids to be mixed together, such as a matrix and an additive, is very large, it may take a long time to achieve fully uniform mixing. Particularly, when the mixing amount for one time is set to be larger so as to increase throughputs or when stepwise mixing is required, such as in a case where liquids A and B are mixed together before a liquid C is mixed therein, it takes longer time for mixing, which often poses an impediment to a reduction in time or cost for the production or the like.

Therefore, there is examined such a method that a first line for distributing a first liquid at a fixed rate is connected to a second line to merge the first liquid with a second liquid at a predetermined rate by using pumps or electromagnetic valves so as to mix together those two kinds of liquids by means of a snake pump or an agitator (stirrer).

With this method, liquid mixing can be performed successively unlike the batch method, and hence the time required for the mixing step can be saved.

However, individual pumps are used to supply the respective liquids in this method, and hence the mixing ratio may be changed depending on the pulsations of the pumps and further affected by operation accuracy of the pumps or the electromagnetic valves. High-speed flow processing is necessary inevitable to mix together large amounts of liquids, and hence the pulsations of the pumps and time lags in metering control become larger, thereby further reducing the accuracy of the mixing ratio.

Further, when the stepwise mixing is necessary, the time lags in metering control are integrated, and hence it becomes more difficult to maintain the accuracy of the mixing ratio.
Patent Document 1: JP 07-047257 A

### DISCLOSURE OF THE INVENTION

### Problems to be Solved by the Invention

It is an object of the present invention to provide a liquid mixing device capable of mixing two or more kinds of liquids in an accurate ratio.

It is another object of the present invention to provide a liquid mixing device capable of mixing together two or more kinds of liquids successively in an accurate ratio without using a batch method.

It is still another object of the present invention to provide a liquid mixing device suitable for the production of a W/O type emulsion, especially W/O type emulsion fuel.

### Means for Solving the Problems

The present invention which has been made to solve the above mentioned problems provides a liquid mixing device including:

a first supply system for supplying a first liquid;

a second supply system for supplying a second liquid; and

a liquid mixing system that receives supply of the first liquid and the second liquid from the first supply system and the second supply system, respectively, in which:

the first supply system communicates to the liquid mixing system through a first flow rate regulation unit having a first path sectional area;

the second supply system communicates to the liquid mixing system through a second flow rate regulation unit having a second path sectional area; and

the first liquid in an amount corresponding to the first path sectional area and the second liquid in an amount corresponding to the second path sectional area are allowed to flow into the liquid mixing system, respectively, by making an inside pressure of the liquid mixing system negative (claim 1).

In the present invention, the first liquid and the second liquid are allowed to flow into the liquid mixing system at flow rates corresponding to the first path sectional area and the second path sectional area through the first flow rate regulation unit and the second flow rate regulation unit having the first path sectional area and the second path sectional area, respectively, by making the inside pressure of the liquid mixing system negative. Thus the first liquid and the second liquid can be mixed together in an accurate mixing ratio without being affected by the pulsation of a pump.

The term “liquid” in the present invention means a substance having a liquid-like property and includes a solution prepared by dissolving solid matter, a suspension prepared by dispersing solid matter, and an emulsion.

The term “path sectional area” in the present invention refers to an area obtained when the path is cut on a plane perpendicular to the flow direction of a liquid in the path.

In the present invention, preferably, the liquid mixing device further includes pressure control means for inverting the inside pressure of the liquid mixing system between negative and positive, periodically; and

first agitating means for agitating the first liquid and the second liquid flowing therein from the liquid mixing system,

in which predetermined amounts of the first liquid and the second liquid are allowed to flow into the first agitating means from the liquid mixing system when the inside pressure of the liquid mixing system becomes positive (claim 2).

In the present invention, predetermined amounts of the first liquid and the second liquid are allowed to flow into the first agitating means at predetermined intervals to be agitated (stirred). Therefore, by setting the amounts of the first liquid and the second liquid which flow into the first agitating means at each interval to a certain small volume, mixing uniformity by agitating the first agitating means can be enhanced.

In the present invention, preferably, the liquid mixing device further includes second agitating means for agitating third liquid and fourth liquid flowing therein from a third supply system and a fourth supply system, respectively, in which:

the third supply system communicates to the second agitating means through a third flow rate regulation unit having a third path sectional area;

the fourth supply system communicates to the second agitating means through a fourth flow rate regulation unit having a fourth path sectional area;

when the inside pressure of the liquid mixing system becomes negative, the pressure of the liquid mixing system is transmitted to the second agitating means so that the third liquid in an amount corresponding to the third path sectional area and the fourth liquid in an amount corresponding to the fourth path sectional area are allowed to flow into the second agitating means, respectively; and

a mixed liquid of the third liquid and the fourth liquid agitated by the second agitating means is supplied into the first supply system as the first liquid (claim 3).

In the above mentioned invention, it is possible to carry out two-stage mixing, that is, the mixing of the third liquid and the fourth liquid and the mixing of the mixed liquid (first liquid) obtained by the above mentioned mixing and the second liquid in a single process.

Further, the third liquid and the fourth liquid are allowed to flow into the second agitating means at flow rates corresponding to the third path sectional area and the fourth path sectional area through the third flow rate regulation unit and the fourth flow rate regulation unit having the third path sectional area and the fourth path sectional area, respectively, and hence the third liquid and the fourth liquid can be mixed together in an accurate mixing ratio in the second agitating means.

Therefore, according to the present invention, there can be realized a liquid mixing device capable of mixing together three kinds of liquids (second liquid to fourth liquid) in an accurate mixing ratio successively in a single process.

In the present invention, preferably, the first and/or second agitating means includes:
an inflow port;
a plurality of branch paths into which a liquid from the inflow port is branched and allowed to flow; and
one or a plurality of integration paths into which liquids from the plurality of branch paths are merged and allowed to flow; and
the liquid flowing in from the inflow port be agitated when passing through the branch paths and the integration paths, being branched into the branch paths and merged into the integration paths and/or colliding with walls of the branch paths or the integration paths (claim 4).

In the above mentioned invention, the liquids can be mixed together very uniformly without producing a lump or nonuniformity by an agitating function which is produced when the liquids are branched into a plurality of branch paths and the liquids in the plurality of branch paths are integrated into the integration paths, or collide with the walls of the branch paths or the integration paths.

In the present invention, preferably, a passage direction of the liquid in the first and/or second agitating means is reversible (claim 5).

In the above mentioned invention, when clogging occurs in the first and/or second agitating means, the clogging can be cleared by reversing the passage direction of the liquid in the first and/or second agitating means.

Alternatively, the liquid mixing device of the present invention may be operated so as to reverse the passage direction of the liquid in the first and/or second agitating means at regular or irregular time intervals. In this case, clogging in the first agitating means and/or the second agitating means can be prevented or suppressed.

Note that, in this specification, the following inventions (1) and (2) are disclosed as inventions related to claim 5.

(1) An agitating device or comminuting device for agitating a liquid or for comminuting (grinding) solid particles dispersed in a liquid by letting the liquid pass through a path having a predetermined path sectional area at a predetermined pressure and/or a predetermined flow rate, wherein:

the device including means for reversing the path direction of the liquid in the path.

(2) An agitating device or comminuting device including a first integration path, a plurality of branch paths communicated to the integration path and a second integration path communicated to the branch paths for agitating a liquid or for comminuting solid particles dispersed in a liquid by letting the liquid pass through the first integration path, the branch paths, and the second integration path, the device further including

means for reversing the path direction of the liquid in the device.

According to the inventions (1) and (2), there is provided an agitating device or comminuting device capable of clearing clogging by reversing the passage direction of the liquid in the device when clogging occurs in the device (path), or an agitating device or comminuting device capable of preventing or suppressing clogging in the device by operating so as to reverse the passage direction of the liquid in the device at regular or irregular time intervals.

In the present invention, preferably, the first path sectional area and/or the second path sectional area is adjustable (claim 6).

In the above mentioned invention, the first and/or second path sectional areas are adjustable, thereby making it possible to adjust easily and arbitrarily the mixing ratio of the first and second liquids.

In the present invention, preferably, the first supply system communicates to the liquid mixing system through a first opening/closing valve capable of performing opening/closing operation;

the second supply system communicates to the liquid mixing system through a second opening/closing valve capable of performing opening/closing operation; and

the first opening/closing valve and the second opening/closing valve perform opening/closing operation synchronously according to the inside pressure of the liquid mixing system (claim 7).

In the above mentioned invention, the first opening/closing valve and the second opening/closing valve can be opened when the inside pressure of the liquid mixing system becomes negative to such an extent that the stable inflow of the first and second liquids from the first and second flow rate regulation units can be expected, thereby making it possible to further improve the accuracy of the mixing ratio of the first and the second liquid.

In the present invention, preferably, the first supply system communicates to the liquid mixing system through a plurality of paths;

at least one of the plurality of paths communicates to the liquid mixing system through a flow rate regulation unit having a path sectional area which is adjustable; and

remaining paths out of the plurality of paths communicate to the liquid mixing system through opening/closing valves capable of performing opening/closing operation independently (claim 8).

In the above mentioned invention, the amount of the first liquid flowing into the liquid mixing system can be roughly set by opening any of the opening/closing valves installed in the paths provided with the opening/closing valves and finely controlled by adjusting the path sectional area in the path having a path sectional area which is adjustable. Therefore, ease of setting the amount of the first liquid flowing into the liquid mixing system or the mixing ratio of the first liquid and the second liquid can be enhanced.

### BRIEF DESCRIPTION OF THE DRAWINGS

FIGS. 1(A) and 1(B) are explanatory diagrams of a liquid mixing device according to an embodiment of the present invention.

FIG. 2 is an explanatory diagram of a liquid mixing device according to another embodiment of the present invention.

FIG. 3 is an explanatory diagram of a liquid mixing device according to another embodiment of the present invention.

FIG. 4 is an explanatory diagram of a liquid mixing device according to another embodiment of the present invention.

FIGS. 5(A) and 5(B) are explanatory diagrams of a liquid mixing device according to another embodiment of the present invention.

FIGS. 6(A) and 6(B) are explanatory diagrams of a liquid mixing device according to another embodiment of the present invention.

FIG. 7 is an explanatory diagram of a liquid mixing device according to another embodiment of the present invention.

FIG. 8 is an explanatory diagram of a liquid mixing device according to another embodiment of the present invention.

FIG. 9 is an explanatory diagram illustrating a configuration of an illustrative agitator used in the present invention.

### BEST MODE FOR CARRYING OUT THE INVENTION

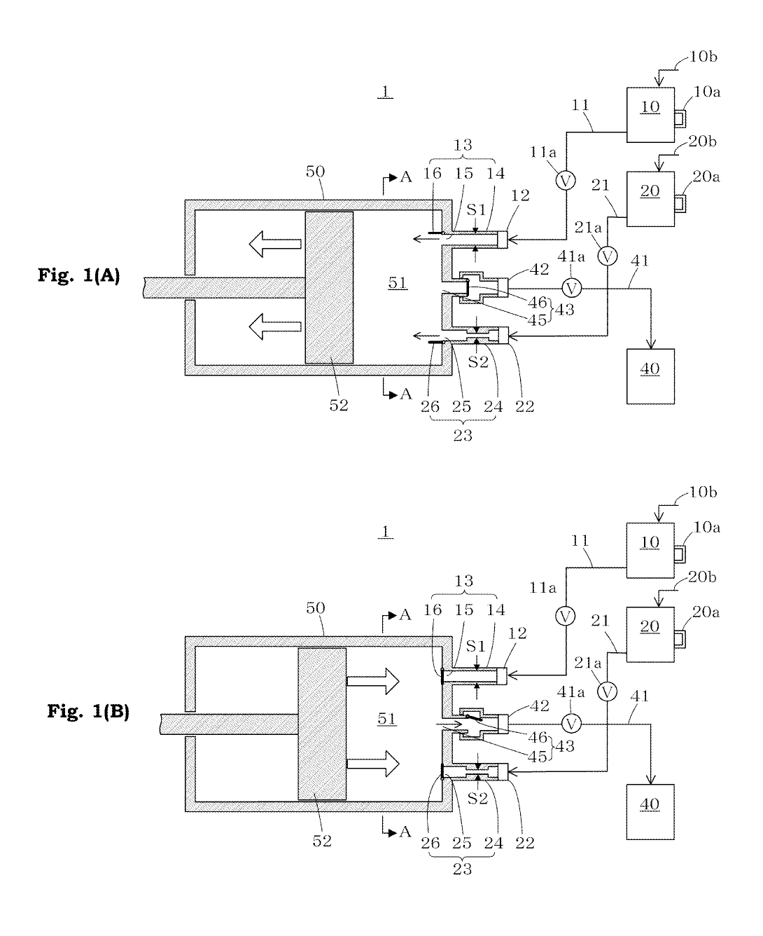

FIGS. 1(A) and 1(B) are explanatory diagrams illustrating a configuration of a liquid mixing device 1 according to an embodiment of the present invention.

As illustrated, the liquid mixing device 1 includes a first container 10 for storing a first liquid, a second container 20 for storing a second liquid, a liquid feed pump 50, and a mixed liquid container 40 for storing a mixed liquid of the first and second liquids which are mixed together in the liquid feed pump 50.

The first container 10 is connected to a first inflow unit 13 of the liquid feed pump 50 through a pipe 11 and a coupler 12, and the second container 20 is connected to a second inflow unit 23 of the liquid feed pump 50 through a pipe 21 and a coupler 22.

The first inflow unit 13 includes a flow rate regulation unit 14 having a predetermined path sectional area S1 and a first inflow port 15 provided with a check valve 16, and the first liquid from the pipe 11 is guided into a pump chamber 51 through the flow rate regulation unit 14 and the first inflow port 15.

The second inflow unit 23 includes a flow rate regulation unit 24 having a predetermined path sectional area S2 and a second inflow port 25 provided with a check valve 26, and the second liquid in the second container 20 is guided into a pump chamber 51 through the flow rate regulation unit 24 and the second inflow port 25.

The liquid feed pump 50 includes the pump chamber 51 with a predetermined capacity and a plunger (or piston) 52 which is reciprocated in the pump chamber 51 by a drive source (not shown), and the pump chamber 51 is provided with an outflow unit 43 in addition to the above mentioned first and second inflow units 13 and 23. Note that, the term “plunger” in this embodiment means a mechanism which reciprocates in the pump chamber 51 to increase or reduce the inside pressure or capacity of the pump chamber 51.

The outflow unit 43 includes an outflow port 45 provided with a check valve 46 and a coupler 42 for connecting a pipe 41, and the mixed liquid container 40 is connected to an end of the pipe 41.

In the above mentioned liquid mixing device 1, the first container 10 and the pipe 11 constitute a first supply system of the present invention, the second container 20 and the pipe 21 constitute a second supply system of the present invention, and the pump chamber 51 constitutes a liquid mixing system of the present invention.

While the plunger 52 moves from the right end position toward the left end position in the pump chamber 51 in the direction illustrated by the arrows in FIG. 1(A) (suction stroke), the inside pressure of the pump chamber 51 becomes negative, the check valve 46 is closed, and the check valves 16 and 26 are opened. As a result, the first liquid and the second liquid are allowed to flow into the liquid mixing system from the first supply system and the second supply system in amounts corresponding to the path sectional area S1 and the path sectional area S2, respectively.

Meanwhile, while the plunger 52 moves from the left end position toward the right end position in the pump chamber 51 in the direction illustrated by the arrows in FIG. 1(B) (discharge stroke), the inside pressure of the pump chamber 51 becomes positive, the check valves 16 and 26 are closed, and the check valve 46 is opened. As a result, a mixed liquid of the first and second liquids which flow into the pump chamber 51 is guided into the mixed liquid container 40 from the outflow port 45 through the coupler 42 and the pipe 41.

In the above mentioned liquid mixing device 1, the flow ratio of the first and second liquids into the pump chamber 51 corresponds to the ratio of the path sectional areas S1 and S2 of the flow rate regulation units 14 and 24. Therefore, the first and second liquids can be mixed together in an accurate mixing ratio without being affected by pumping pulsation.

Note that, the flow rates of the first and second liquids into the pump chamber 51 also depend upon the properties of the first and second liquids and the inside resistances and pressures of the pipes 11 and 12, and hence the mixing ratio of the first and second liquids in the pump chamber 51 is not always equal to the ratio of the path sectional areas S1 and S2. However, it is easy to determine experimentally the path sectional areas S1 and S2 with which the required mixing ratio can be achieved.

The liquid mixing device 1 may be provided with means for keeping the inside pressures of the first and second supply systems constant (for example, liquid level sensors 10a and 20a and supply pipes 10b and 20b), or means for keeping the temperatures of the first supply system, the second supply system and/or the liquid mixing system constant (for example, a thermostat bath, heater, or cooler) in order to prevent changes in the properties (such as viscosity) of the first supply system, the second supply system and/or the mixed liquid thereof. As a result, changes over time in the mixing ratio of the first and second liquids can be prevented.

The liquid mixing device 1 may additionally be provided with a level for leveling the liquid feed pump 50 and flow meters 11a, 21a, and 41a for monitoring the flow rates and/or mixing ratio of the first liquid and/or the second liquid and/or the flow rate of the mixed liquid.

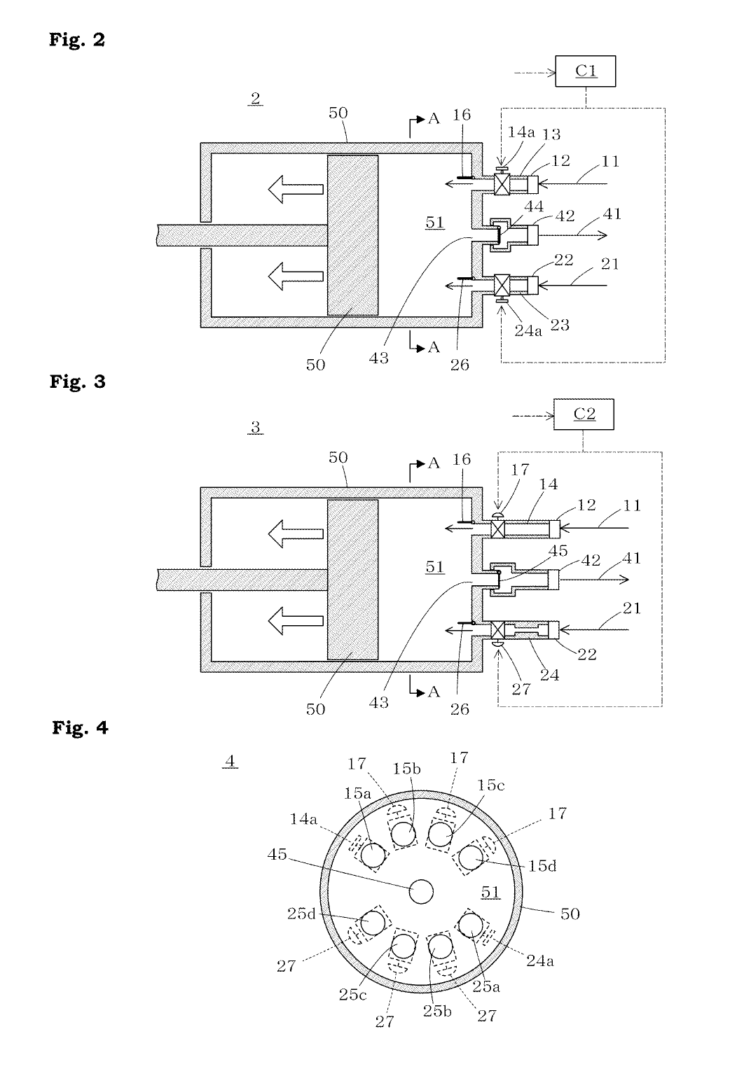

FIG. 2 is an explanatory diagram illustrating a configuration of a liquid mixing device 2 according to another embodiment of the present invention. Note that, in FIG. 2, the containers 10, 20, and 40 are not shown.

The liquid mixing device 2 has the same configuration as that of the liquid mixing device 1 except that it includes valves 14a and 24a capable of adjusting the path sectional area in place of the flow rate regulation units 14 and 24 in the liquid mixing device 1.

In the liquid mixing device 2, the same effect as that of the liquid mixing device 1 can be obtained. In addition, the liquid mixing device 2 has additional advantage that the mixing ratio of the first and second liquids in the liquid mixing system can be adjusted to any value by controlling the opening degrees of the valves 14a and 24a.

Note that, any valve capable of regulating the flow rate successively or stepwise when the inside pressure of the pump chamber 51 becomes negative by changing the path sectional area, such as a bellows valve, needle valve, or diaphragm valve, may be used as the valves 14a and 24a.

In the liquid mixing device 2, when the kinds, temperatures, and viscosities of the first and second liquids and the inside pressures of the first and second supply systems are made constant, the relationship between the opening degrees of the valves 14a and 24a and the mixing ratio of the first and second liquids and/or the amount of the produced mixed liquid (flow rate in the pipe 41) can be obtained through experiments.

Therefore, when a control unit C1 is constructed such that the opening degrees of the valves 14a and 24a can be controlled, and the relationship obtained as described above is recorded in the control unit C1, the opening degrees of the valves 14a and 24a can be automatically controlled by the control unit C1 based on the mixing ratio of the first and second liquids and/or the amount of the produced mixed liquid input into the control unit C1.

Further, when the relationship between the opening degrees of the valves 14a and 24a and the mixing ratio of the first and second liquids and/or the amount of the produced mixed liquid is obtained in advance for various conditions (the kinds, temperatures, and viscosities of the first and second liquids and the inside pressures of the first and second supply systems) and recorded in the control unit C1, even if those conditions change, the control unit C1 can also be constructed such that the opening degrees of the valves 14a and 24a can be automatically controlled based on those conditions and the mixing ratio of the first and second liquids in the mixed liquid to be produced and/or the amount of the produced mixed liquid.

FIG. 3 is an explanatory diagram illustrating a configuration of a liquid mixing device 3 according to a still further embodiment of the present invention.

The liquid mixing device 3 has the same configuration as that of the liquid mixing device 1 in FIGS. 1(A) and 1(B), except that electromagnetic valves 17 and 27 which are opened and closed by a control unit C2 are additionally provided between the flow rate regulation units 14 and 24 and the check valves 16 and 26, respectively, in the liquid mixing device 1 in FIGS. 1(A) and 1(B).

In the liquid mixing device 3, the inside pressure of the pump chamber 51, the displacement of the plunger or the load of the plunger is detected by a sensor (not shown), and the control unit C2 closes the electromagnetic valves 17 and 27 synchronously when the inside pressure of the pump chamber 51 becomes a certain value or more and opens the electromagnetic valves 17 and 27 synchronously when the inside pressure of the pump chamber 51 becomes a certain value or less.

Therefore, in the liquid mixing device 3, the first and second liquids are allowed to flow into the pump chamber only when the negative inside pressure of the pump chamber 51 falls within a predetermined range, and an additional effect that the mixing ratio of the first and second liquids can be controlled more accurately can be obtained in addition to the same effect as that of the liquid mixing device 1.

Note that, in the liquid mixing device 3, the flow rate regulation units 14 and 24 may also be substituted by the valves 14a and 24a in the liquid mixing device 2, or the control unit C1 may also be constructed such that it automatically controls the opening degrees of the valves 14a and 24a based on the required mixing ratio of the first and second liquids and/or the required amount of the produced mixed liquid.

FIG. 4 is a sectional view cut on line A-A in FIGS. 1 to 3 of a liquid mixing device 4 according to a further embodiment of the present invention.

The liquid mixing device 4 differs from the liquid mixing devices 1 to 3 in that it has the plurality of first inflow ports 15a and 15d and second inflow ports 25a to 25d (four each in the illustrated embodiment), the first inflow ports 15a to 15d are connected to the first container 10 through pipe systems, each including the same check valve 16, coupler 12, and pipe 11, etc., as in the liquid mixing devices 1 to 3, and the second inflow ports 25a to 25d are connected to the second container 20 through pipe systems, each including the same check valve 26, coupler 22, and pipe 21, etc., as in the liquid mixing devices 1 to 3. Note that, in FIG. 4, the check valves 16 and 26 provided to the first inflow ports 15a to 15d and the second inflow ports 25a to 25d are not shown.

In the liquid mixing device 4, it is preferred that a valve 14a capable of adjusting the path sectional area be provided in the pipe system of at least one first inflow port 15a and that an electromagnetic valve 17 which can be opened and closed independently by hand or electronic control be provided in the pipe systems of all or some of the other first inflow ports 15b to 15d. It is also preferred that a valve 24a capable of adjusting the path sectional area be provided in the pipe system of at least one second inflow port 25a and that an electromagnetic valve 27 which can be opened and closed independently by hand or electronic control be provided in the pipe systems of all or some of the other second inflow ports 25b to 25d.

According to the above mentioned configuration, the amounts of the first and second liquids flowing into the pump chamber 51 are roughly set by opening or closing the electromagnetic valves 17 and 27 of the first inflow ports 15b to 15d and the second inflow ports 25b to 25d and finely adjusted by the valves 14a and 24a of the first and second inflow ports 15a and 25a. Thus, it is possible to facilitate the work of setting the mixing ratio of the first and second liquids.

For example, when the path sectional areas of the flow rate regulation units 14 of the first inflow ports 15b to 15d are all S1 and the path sectional areas of the flow rate regulation units 24 of the second inflow ports 25b to 25d are all S2, the mixing ratio of the first and second liquids can be set to “2×S1:3×S2” by opening the electromagnetic valves 17 of two of the first inflow ports 15b and 15c and the electromagnetic valves 27 of three of the second inflow ports 15b to 15d, and this mixing ratio can be finely controlled by the valves 14a and 24a of the first and second inflow ports 15a and 25a as required.

Note that, in the liquid mixing device 4, when the control unit C1 is constructed such that it automatically controls the opening degrees of the valves 14a and 24a, and the relationship between the opening/closing of the first inflow ports 15b to 15d and the second inflow ports 25b to 25d and the opening degrees of the valves 14a and 24a and the mixing ratio of the first and second liquids and/or the amount of the produced mixed liquid is obtained for various conditions (kinds, temperatures, and viscosities of the first and second liquids and the inside pressures of the first and second supply systems), the control unit C1 and C2 may be constructed such that it automatically controls the opening degrees of the valves 14a and 24a and the opening/closing of the electromagnetic valves 17 and 27 based on the various conditions and the desired mixing ratio and/or the desired amount of the produced mixed liquid.

Although FIGS. 1 to 4 illustrate that two supply systems (first and second supply systems) for supplying two kinds of liquids (first and second liquids) are connected to the liquid mixing devices 1 to 4, one or more additional supply systems for supplying one or more kinds of liquids into the liquid mixing system may be connected to the liquid mixing system in the liquid mixing devices 1 to 4. In this case, the additional supply system(s) may have the same configuration as that of the first or second supply systems which are described for the liquid mixing devices 1 to 4.

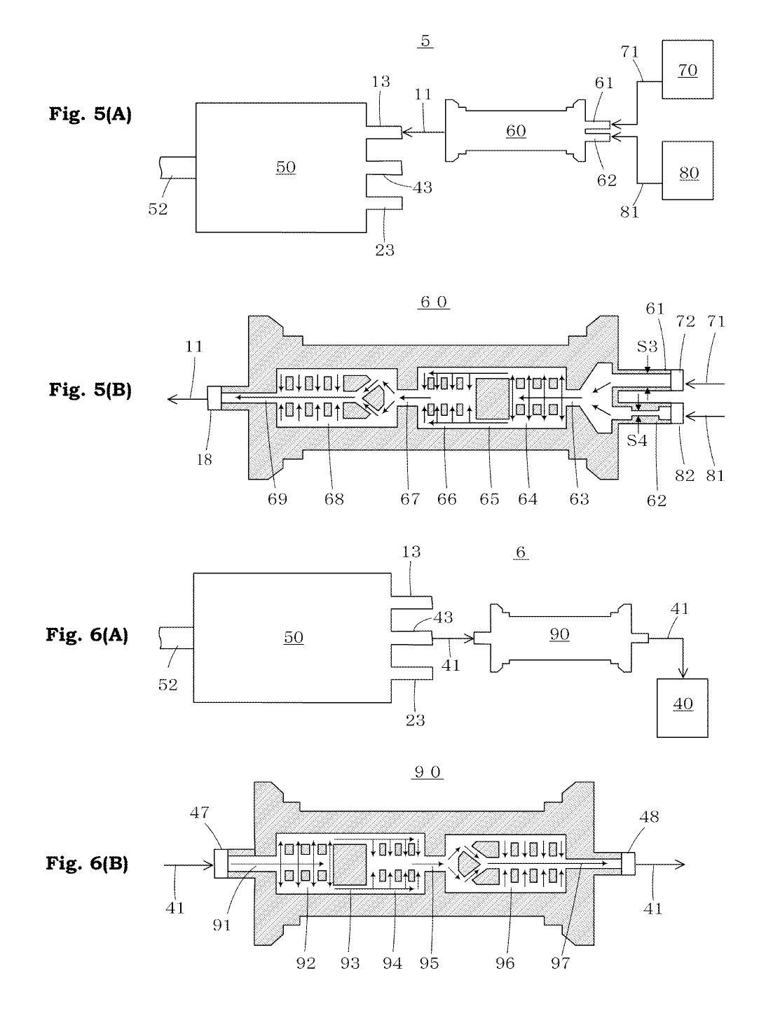

FIGS. 5(A) and 5(B) are explanatory diagrams illustrating the configuration of a liquid mixing device 5 according to a still further embodiment of the present invention.

As illustrated in FIG. 5(A), the liquid mixing device 5 has the same configuration as that of the liquid mixing devices 1 to 4 except that the first supply system for supplying the first liquid into the liquid feed pump 50 includes a third container 70 for storing a third liquid, a fourth container 80 for storing a fourth liquid, an agitator 60 for agitating the third and fourth liquids supplied from the third and fourth containers 70 and 80 through pipes 71 and 81, and the pipe 11 for introducing a mixed liquid of the third and fourth liquids which are uniformly mixed together by agitating with the agitator 60 into the first inflow unit 13 of the liquid feed pump 50 as a first liquid. Note that, in FIGS. 5(A) and 5(B), components (pipes 21 and 41, second container 20, and mixed liquid container 40, and the like) subsequent to the inflow unit 13 and the outflow unit 43 are not shown.

FIG. 5(B) is a sectional view of the above mentioned agitator 60.

As illustrated in the figure, the pipe 71 is connected to a third inflow unit 61 having a flow rate regulation unit with a predetermined path sectional area S3 through a coupler 72, and the pipe 81 is connected to a fourth inflow unit 62 having a flow rate regulation unit with a predetermined path sectional area S4 through a coupler 82.

The third and fourth inflow units 61 and 62 are connected to a common inflow port 63 which is branched into a plurality of branch paths in a first branching block 64, those branch paths are integrated into two integration paths in a first merger block 65, and the two integration paths are branched into a plurality of branch paths again in a second branching block 66.

Those branch paths are integrated into a single integration path in a second merger block 67, the single integration path is branched into a plurality of branch paths in a third branching block 68, those branch paths are integrated into a single integration path in a third merger block 69 in the end, and the integration path is connected to the pipe 11 by a coupler 18.

In the above mentioned liquid mixing device 5, the third container 70 and the pipe 71 constitute the third supply system of the present invention, and the fourth container 80 and the pipe 81 constitute the fourth supply system of the present invention.

In the above mentioned liquid mixing device 5, when the plunger 52 moves in the direction illustrated by the arrows in FIG. 1(A), the inside pressure of the pump chamber 51 becomes negative and the check valve 16 is opened, whereby the inside pressure of the agitator 60 becomes negative through the pipe 11. As a result, the third liquid and the fourth liquid are introduced into the inflow port 63 from the third supply system and the fourth supply system through the third and fourth inflow units 61 and 62 in amounts corresponding to the path sectional area S3 and the path sectional area S4, respectively.

The third and fourth liquids flowing into the inflow port 63 are agitated when they pass through the branch paths and the integration paths, are branched into the branch paths, are merged into the integration paths and collide with the walls of the branch paths and the integration paths while they pass through the first to third branching blocks 64, 66, and 68 and the first to third merger blocks 65, 67, and 69, whereby the third and fourth liquids are guided into the pipe 11 in a state in which they are mixed together very uniformly.

The mixed liquid of the third and fourth liquids in the pipe 11 is sucked by the negative inside pressure of the pump chamber 51 to flow into the pump chamber 51 through the first inflow unit 13 and mixed with the second liquid which flows from the pipe 21 and the second inflow unit 23 by suction likewise to become a mixed liquid of the second to fourth liquids which is then supplied into the pipe 41 from the outflow unit 43 when the plunger 52 moves in the direction illustrated by the arrows in FIG. 1(B).

In the above mentioned liquid mixing device 5, it is possible to carry out two-stage mixing, that is, the mixing of the third and fourth liquids and the mixing of a mixed liquid (first liquid) obtained by the above mentioned mixing and the second liquid in a single process.

Further, the third and fourth liquids are agitated by the agitator 60 constructed such that the inflow port is branched into a plurality of branch paths and the branch paths are integrated into one or a plurality of integration paths. Thus, the third and fourth liquids can be mixed together very uniformly without producing a lump or nonuniformity.

Therefore, for example, even when compatibility between the third and fourth liquids is low or even when the mixing ratio between the third and fourth liquids greatly differ from each other (path sectional areas S3 and S4 greatly differ from each other), the third and fourth liquids can be flown into the liquid mixing system in a state in which they are uniformly mixed together, thereby making it possible to make the mixing state of the mixed liquid of the second to fourth liquids supplied from the outflow unit 43 much better.

It is preferred that the whole agitator 60 or at least the surface of the path wall be made of high-hardness metal such as super steel alloy or ceramic in order to reduce abrasion by the flow resistances of the third and fourth liquids.

Note that, while the agitator 60 has the third and fourth inflow units 61 and 62 which are the same as the first and second inflow units 13 and 23 in the liquid mixing device 1 in configuration, respectively, in the above mentioned embodiment, the third and fourth inflow units 61 and 62 of the agitator 60 may be the same as the first and second inflow units 13 and 23 in the liquid mixing devices 2 to 4 in configuration, respectively.

While in the above mentioned embodiment, there is exemplified a case in which two kinds of liquids (third and fourth liquids) are mixed together in the agitator 60, three or more kinds of liquids may be mixed together in the agitator 60 by additionally providing the same inflow unit(s) as the third and fourth inflow units 61 and 62 in the agitator 60 and supplying another kind of a liquid from an additional supply system(s).

While in the above mentioned embodiment, there is exemplified a case in which two kinds of liquids (third and fourth liquids) are mixed together by using the agitator 60 only in the first supply system, two or more kinds of liquids may also be mixed together in the second supply system or additional supply system(s) connected to the above mentioned liquid mixing system illustrated in FIGS. 1 to 4 by using the agitator 60 in those supply systems.

The liquid mixing device 5 may have means for keeping the inside pressures of the third and fourth supply systems constant (for example, liquid level sensors or supply pipes) or means for keeping the temperatures of the third and fourth supply systems constant (for example, thermostat bath, heater, or cooler) in order to prevent changes in the properties (such as viscosity) of the third and fourth liquids and/or the mixed liquid thereof, thereby making it possible to prevent changes in time in the mixing ratio of the third and fourth liquids.

FIGS. 6(A) and 6(B) are explanatory diagrams illustrating the configuration of a liquid mixing device 6 according to a still further embodiment of the present invention.

As illustrated in FIG. 6(A), the liquid mixing device 6 has the same configuration as that of the liquid mixing devices 1 to 5 except that it has an agitator 90 for agitating the first and second liquids supplied from the pump chamber 51 between the outflow unit 43 and the mixed liquid container 40. Note that, in FIGS. 6(A) and 6(B), components (such as pipes 11 and 12, second container 20, mixed liquid container 40, and agitator 60) subsequent to the inflow units 13 and 23 are not shown.

FIG. 6(B) is a sectional view of the above mentioned agitator 90.

As illustrated in the figure, the pipe 41 is connected to the inflow port 91 of the agitator 90 through a coupler 47, the inflow port 91 is branched into a plurality of branch paths in a first branching block 92, those branch paths are integrated into two integration paths in a first merger block 93, and the two integration paths are branched into a plurality of branch paths again in a second branching block 94.

Those branch paths are integrated into a single integration path in a second merger block 95, the single integration path is branched into a plurality of branch paths in a third branching block 96, those branch paths are integrated into a single integration path in a third merger block 97 in the end, and the single integration path is connected to the pipe 41 by a coupler 48.

In the above mentioned liquid mixing device 6, when the plunger 52 is moved in the direction illustrated by the arrows in FIG. 1(B), the inside pressure of the pump chamber 51 becomes positive, whereby the check valve 46 is opened and the mixed liquid of the first and second liquids in the pump chamber 51 flows into the inflow port 91 of the agitator 90 through the outflow unit 43, the pipe 41 and the coupler 47.

The above mentioned mixed liquid flowing into the inflow port 91 is agitated when it passes through the branch paths and the integration paths, is branched into the branch paths, merged into the integration paths and collides with the walls of the branch paths and the integration paths while it passes through the first to third branching blocks 92, 94, and 96 and the first to third merger blocks 93, 95, and 97, whereby the first and second liquids are guided into the pipe 41 from the coupler 48 in a state in which they are mixed together very uniformly.

In the above mentioned liquid mixing device 6, the first and second liquids are agitated by the agitator 90 constructed such that the inflow port is branched into a plurality of branch paths and the branch paths are integrated into one or a plurality of integration paths. Thus, the first and second liquids can be mixed together very uniformly without producing a lump or nonuniformity.

In the liquid mixing device 6, the first and second liquids are agitated by the agitator 90 in a total amount corresponding to the capacity of the liquid feed pump 50 (the product of the stroke of the plunger 52 and the sectional area of the pump chamber 51) each time. Thus the mixing of the first and second liquids can be made more perfect by setting the capacity of the liquid feed pump 50 to a relatively small appropriate value.

Therefore, for example, even when compatibility between the first and second liquids is low or even when a difference of the mixing ratio of the first and second liquids greatly differ from each other (path sectional areas S1 and S2 greatly differ from each other), the first and second liquids can be mixed together very uniformly.

It is preferred that the whole agitator 90 or at least the surface of the path wall be made of high-hardness metal such as super steel alloy or ceramic in order to reduce abrasion by the flow resistances of the first and second liquids.

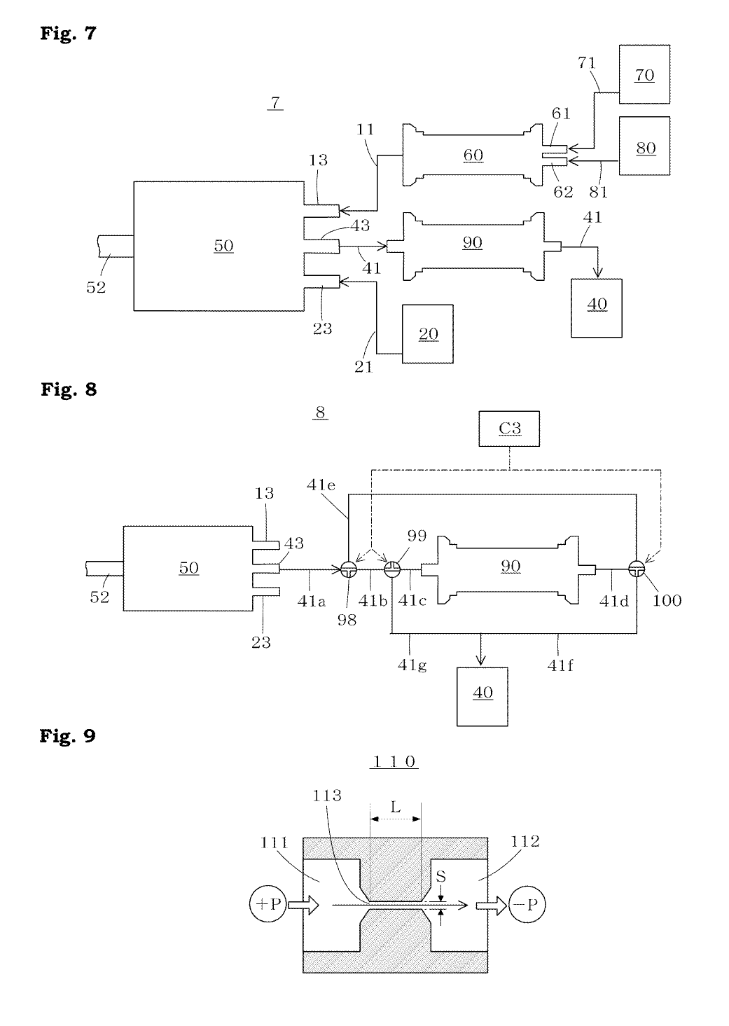

FIG. 7 is an explanatory diagram illustrating the configuration of a liquid mixing device 7 according to a particularly preferred embodiment of the present invention which can be advantageously used for the production of emulsion fuel and the like.

In the illustrated liquid mixing device 7, the third and fourth containers 70 and 80, the pipes 71, 81, and 11, and the agitator 60 are the same as the corresponding components of the liquid mixing device 5 in configuration, and the mixed liquid container 40, the pipe 41, and the agitator 90 are the same as the corresponding components of the liquid mixing device 6 in configuration.

In the above mentioned liquid mixing device 7, the third and fourth liquids can be mixed together very uniformly in the agitator 60 in an accurate mixing ratio without producing a lump or nonuniformity, and further a mixed liquid of the third and fourth liquids can be mixed with the second liquid very uniformly in the agitator 90 in an accurate mixing ratio without producing a lump or nonuniformity.

Therefore, fuel (such as light oil) is stored in the first container 70, an additive (such as an emulsifier) is stored in the fourth container 80, and they are mixed together in a greatly different mixing ratio (for example, the fuel and the additive are mixed in terms of a weight ratio of 70:1) in the agitator 60, and water is stored in the second container 20 and is mixed with a mixture of the fuel and the additive in the agitator 90 (for example, in a mixing ratio of the mixture of the fuel and the additive to water of 71:29 in terms of weight ratio), thereby making it possible to produce emulsion fuel and the like efficiently and successively in a single process.

In this case, the agitator 60 has the above mentioned configuration, and hence the fuel and the additive can be mixed together (emulsified) very uniformly in a high mixing ratio without producing a lump. Further, the agitator 90 has the above mentioned configuration, and hence satisfactory emulsion fuel and the like containing fine water particles uniformly dispersed in a fuel phase can be produced by mixing (emulsifying) the fuel with water which has low compatibility with fuel.

Further, the mixing ratio of the fuel, the additive, and water is determined by the amounts of the components flowing into the agitator 60 or the pump chamber 51 from the inflow units 61, 62, and 23 having predetermined path sectional areas (S3, S4, S2) by suction when the inside pressure of the pump chamber 51 is made negative. Thus, the accuracy of the mixing ratio of the components is improved, thereby making it possible to enhance the quality stability of the produced emulsion fuel.

FIG. 8 is an explanatory diagram illustrating the configuration of a liquid mixing device 8 according to a still further embodiment of the present invention. Note that, in FIG. 8, components subsequent to the inflow units 13 and 23 are not shown.

As illustrated in the figure, the liquid mixing device 8 has the same configuration as that of the liquid mixing devices 6 and 7 except that the agitator 90 is connected to the outflow unit 43 through three-way valves 98 to 100 controlled by a control unit C3 and pipes 41a to 41e and to the mixed liquid container 40 through the three-way valves 99 and 100 and pipes 41f and 41g.

The control unit C3 performs a switching control between a first state in which the three-way valves 98 and 99 sequentially circulate the liquid from the pipe 41a into the pipes 41b and 41c and the three-way valve 100 circulates the liquid from the pipe 41d into the pipe 41f, and a second state in which the three-way valves 98 and 100 sequentially circulate the liquid from the pipe 41a into the pipes 41e and 41d and the three-way valve 99 circulates the liquid from the pipe 41c into the pipe 41g.

In the liquid mixing device 8, for example, when clogging occurs in the agitator 90 due to the inclusion of foreign matter or for another reason during operation in the first state, the control unit C3 switches the three-way valves 98 to 100 to the second state so that the clogging can be cleared by reversing the path direction of the liquid in the agitator 90.

Alternatively, by switching the three-way valves 98 to 100 between the first state and the second state at regular or irregular time intervals by the control unit C3, clogging in the agitator 90 can be prevented or suppressed, or partial wear, i.e., uneven abrasion of the wall of the path in the agitator 90 can be prevented.

Therefore, in the liquid mixing device 8, the agitator 90 having branch paths and integration paths with smaller path sectional areas can be used, whereby the mixing uniformity of the first and second liquids can be further enhanced. Alternatively, even when the first and second liquids contain solid particles having a certain size or even when foreign matter may be contained, operation becomes possible. Thus, the application range of the liquid mixing device 8 can be expanded.

Note that, it is also possible to constitute the agitator 60 in the liquid mixing devices 5 and 7 shown in FIGS. 5(A) and 5(B) and FIG. 7 such that the passage direction of the liquid in the agitator 60 can be reversed, by employing the same configuration as that of the liquid mixing device 8. In this case, clogging in the agitator 60 can be cleared or prevented.

FIG. 9 is an explanatory diagram of an agitator 110 which is a variation of the agitators 60 and 90 in the liquid mixing devices 5 to 8.

As illustrated in the figure, the agitator 110 has an inflow port 111 and an outflow port 112 which are connected to each other by a path 113 having a predetermined path sectional area S and a path length L. By making the pressure of the liquid in the inflow port 111 positive (+P) or by making the pressure of the liquid in the outflow port 112 negative (−P), the liquid on the inflow port 111 side is moved toward the outflow port 112 through the path 113.

In the agitator 110, the liquid can be agitated and mixed effectively by a function such as cavitation or shear force generated when the liquid passes through the path 113 by setting the pressure (+P or −P) applied to the inflow port 111 or the outflow port 112, the flow rate of the liquid passing through the path 113, the path sectional area S, and path length L of the path 113 and the like to suitable values, and the same effect as that of the agitators 60 and 90 of the liquid mixing devices 5 to 8 can be obtained.

Note that, although the path 113 is straight in the figure, it may be curved or bent. In this case, an agitating and mixing effect which is equal to or larger than the effect when the path is straight can be obtained by the change of the traveling direction of the liquid or collision with the inner wall of the path. The path sectional area S and the sectional shape do not always need to be the same along the entire length of the path 113, and the sectional shape of the path 113 may be circular, elliptic, rectangular, or other desired shape. Further, the inflow port 111 and the outflow port 112 may be connected with each other by a plurality of paths 113.

The above mentioned agitators 60, 90, and 110 may be used as an device for comminuting solid particles (making fine solid particles) dispersed in a liquid such as water by (1) forming the whole agitator or at least the surface of the path wall from high-hardness metal such as super steel alloy or ceramic, and/or by (2) adjusting the path sectional areas and lengths of the branch paths and the integration paths in the agitators 60 and 90, the numbers of the branch paths and the integration paths, the curvature of the paths in branching or merger blocks, and the pressure to be applied to the liquid for letting it pass through the agitators 60 and 90 according to the size and properties of the particles to be comminuted, or by (3) adjusting the path sectional area S, length L of the path 113, the number of the paths 113, the sectional shape of the path 13, and the pressure (+P or −P) to be applied to the liquid for letting it pass through the path 13 in the agitator 110 according to the size and properties of the particles to be comminuted.

Even when the passage direction of the liquid in the agitators 60, 90, and 110 is reversed, the agitators 60, 90, and 110 can obtain the effect of agitating the liquid or comminuting solid particles dispersed in the liquid.

In the device 60, 90, and 110 for agitating the liquid or the device 60, 90, and 110 for comminuting the solid particles as above, the passage direction of the liquid in the device can be reversed by the technique or configuration explained in relation with FIG. 8 or the equivalent technique or configuration to the same, whereby clogging in the device 60, 90, and 110 can be cleared or prevented, and an effect such as the prevention of partial wear can be obtained.

While the present invention has been described based on the illustrative embodiments, it is to be understood that the present invention is not limited thereto and that various changes and modifications may be made within the scope of the appended claims.

For example, while in the above mentioned embodiments, there is exemplified a case in which the liquid feed pump is used as means for making the inside pressure of the liquid mixing system negative, the inside pressure of the liquid mixing system may be made negative by any other method or means.

Further, while the first to fourth supply systems are connected to the containers 10, 20, 70, and 80 supplying the first to fourth liquids, respectively, and the liquid mixing system is connected to the container 40 for storing the mixed liquid in the above mentioned embodiments, the first to fourth liquids may be supplied into the first to fourth supply systems from the line of the previous processes, and the mixed liquid from the liquid mixing system may be directly supplied into the line of the subsequent process.

The configuration of the device and the material, shape, and size of each member in the above mentioned embodiments are just examples and the present invention is not limited thereto.

### INDUSTRIAL APPLICABILITY

The liquid mixing device of the present invention can be used to produce emulsion fuel by mixing together fuel, an additive and water, and can widely be used for the mixings of two or more kinds of liquids required in variety of industrial fields.

The agitators 60, 90, and 110 illustrated in the above mentioned embodiments can be used as an device for mixing together (emulsifying) two or more kinds of liquids in a liquid mixing device, and also as a comminuting device or a grinding device for comminuting (grinding) solid particles dispersed in a liquid.

1. A liquid mixing device, comprising:
a first supply system for supplying a first liquid;
a second supply system for supplying a second liquid; and
a liquid mixing system that receives supply of the first liquid and the second liquid from the first supply system and the second supply system, respectively, wherein:
the first supply system communicates to the liquid mixing system through a first flow rate regulation unit having a first path sectional area;
the second supply system communicates to the liquid mixing system through a second flow rate regulation unit having a second path sectional area; and
the first liquid in an amount corresponding to the first path sectional area and the second liquid in an amount corresponding to the second path sectional area are allowed to flow into the liquid mixing system, respectively, by the suction from the liquid mixing system by making an inside pressure of the liquid mixing system negative.

2. A liquid mixing device according to claim 1, further comprising a second agitating mechanism for agitating third liquid and fourth liquid flowing therein from a third supply system and a fourth supply system, respectively, wherein:
the third supply system communicates to the second agitating mechanism through a third flow rate regulation unit having a third path sectional area;
the fourth supply system communicates to the second agitating mechanism through a fourth flow rate regulation unit having a fourth path sectional area;
when the inside pressure of the liquid mixing system becomes negative, the pressure of the liquid mixing system is transmitted to the second agitating mechanism so that the third liquid in an amount corresponding to the third path sectional area and the fourth liquid in an amount corresponding to the fourth path sectional area are allowed to flow into the second agitating mechanism, respectively; and
a mixed liquid of the third liquid and the fourth liquid agitated by the second agitating mechanism is supplied into the first supply system as the first liquid.

3. A liquid mixing device according to claim 1, wherein the first path sectional area and/or the second path sectional area is adjustable.

4. A liquid mixing device according to claim 1, wherein:
the first supply system communicates to the liquid mixing system through a first opening/closing valve capable of performing opening/closing operation;
the second supply system communicates to the liquid mixing system through a second opening/closing valve capable of performing opening/closing operation; and
the first opening/closing valve and the second opening/closing valve perform opening/closing operation synchronously according to the inside pressure of the liquid mixing system.

5. A liquid mixing device according to claim 1, wherein:
the first supply system communicates to the liquid mixing system through a plurality of paths;
at least one of the plurality of paths communicates to the liquid mixing system through a flow rate regulation unit having a path sectional area which is adjustable; and
remaining paths out of the plurality of paths communicate to the liquid mixing system through opening/closing valves capable of performing opening/closing operation independently.

6. A liquid mixing device according to claim 1, further comprising:
a pressure control mechanism for inverting the inside pressure of the liquid mixing system between negative and positive, periodically; and
a first agitating mechanism for agitating the first liquid and the second liquid flowing therein from the liquid mixing system,
wherein predetermined amounts of the first liquid and the second liquid are allowed to flow into the first agitating mechanism from the liquid mixing system when the inside pressure of the liquid mixing system becomes positive.

7. A liquid mixing device according to claim 6, wherein a passage direction of the liquid in the first agitating mechanism is reversible.

8. A liquid mixing device according to claim 6, wherein the first path sectional area and/or the second path sectional area is adjustable.

9. A liquid mixing device according to claim 6, wherein:
the first supply system communicates to the liquid mixing system through a first opening/closing valve capable of performing opening/closing operation;
the second supply system communicates to the liquid mixing system through a second opening/closing valve capable of performing opening/closing operation; and
the first opening/closing valve and the second opening/closing valve perform opening/closing operation synchronously according to the inside pressure of the liquid mixing system.

10. A liquid mixing device according to claim 6, wherein:
the first supply system communicates to the liquid mixing system through a plurality of paths;
at least one of the plurality of paths communicates to the liquid mixing system through a flow rate regulation unit having a path sectional area which is adjustable; and
remaining paths out of the plurality of paths communicate to the liquid mixing system through opening/closing valves capable of performing opening/closing operation independently.

11. A liquid mixing device according to claim 6, further comprising a second agitating mechanism for agitating third liquid and fourth liquid flowing therein from a third supply system and a fourth supply system, respectively, wherein:
the third supply system communicates to the second agitating mechanism through a third flow rate regulation unit having a third path sectional area;
the fourth supply system communicates to the second agitating mechanism through a fourth flow rate regulation unit having a fourth path sectional area;
when the inside pressure of the liquid mixing system becomes negative, the pressure of the liquid mixing system is transmitted to the second agitating mechanism so that the third liquid in an amount corresponding to the third path sectional area and the fourth liquid in an amount corresponding to the fourth path sectional area are allowed to flow into the second agitating mechanism, respectively; and
a mixed liquid of the third liquid and the fourth liquid agitated by the second agitating mechanism is supplied into the first supply system as the first liquid.

12. A liquid mixing device according to claim 11, wherein:
the second agitating mechanism comprises:
an inflow port;
a plurality of branch paths into which a liquid from the inflow port is branched and allowed to flow; and
one or a plurality of integration paths into which liquids from the plurality of branch paths are merged and allowed to flow; and
the liquid flowing in from the inflow port is agitated when passing through the branch paths and the integration paths, being branched into the branch paths, being merged into the integration paths and/or colliding with walls of the branch paths or the integration paths.

13. A liquid mixing device according to claim 11, wherein a passage direction of the liquid in the second agitating mechanism is reversible.

14. A liquid mixing device according to claim 6, wherein:
the first agitating mechanism comprises:
an inflow port;
a plurality of branch paths into which a liquid from the inflow port is branched and allowed to flow; and
one or a plurality of integration paths into which liquids from the plurality of branch paths are merged and allowed to flow; and
the liquid flowing in from the inflow port is agitated when passing through the branch paths and the integration paths, being branched into the branch paths, being merged into the integration paths and/or colliding with walls of the branch paths or the integration paths.

15. A liquid mixing device according to claim 14, wherein a passage direction of the liquid in the first agitating mechanism is reversible.

16. A liquid mixing device according to claim 14, further comprising a second agitating mechanism for agitating third liquid and fourth liquid flowing therein from a third supply system and a fourth supply system, respectively, wherein:
the third supply system communicates to the second agitating mechanism through a third flow rate regulation unit having a third path sectional area;
the fourth supply system communicates to the second agitating mechanism through a fourth flow rate regulation unit having a fourth path sectional area;
when the inside pressure of the liquid mixing system becomes negative, the pressure of the liquid mixing system is transmitted to the second agitating mechanism so that the third liquid in an amount corresponding to the third path sectional area and the fourth liquid in an amount corresponding to the fourth path sectional area are allowed to flow into the second agitating mechanism, respectively; and
a mixed liquid of the third liquid and the fourth liquid agitated by the second agitating mechanism is supplied into the first supply system as the first liquid.

17. A liquid mixing device according to claim 16, wherein:
the second agitating mechanism comprises:
an inflow port;
a plurality of branch paths into which a liquid from the inflow port is branched and allowed to flow; and
one or a plurality of integration paths into which liquids from the plurality of branch paths are merged and allowed to flow; and
the liquid flowing in from the inflow port is agitated when passing through the branch paths and the integration paths, being branched into the branch paths, being merged into the integration paths and/or colliding with walls of the branch paths or the integration paths.

18. A liquid mixing device according to claim 17, wherein a passage direction of the liquid in the second agitating mechanism is reversible.

19. A liquid mixing device according to claim 14, wherein the first path sectional area and/or the second path sectional area is adjustable.

20. A liquid mixing device according to claim 19, wherein:
the first supply system communicates to the liquid mixing system through a first opening/closing valve capable of performing opening/closing operation;
the second supply system communicates to the liquid mixing system through a second opening/closing valve capable of performing opening/closing operation; and
the first opening/closing valve and the second opening/closing valve perform opening/closing operation synchronously according to the inside pressure of the liquid mixing system.

21. A liquid mixing device according to claim 20, wherein:
the first supply system communicates to the liquid mixing system through a plurality of paths;
at least one of the plurality of paths communicates to the liquid mixing system through a flow rate regulation unit having a path sectional area which is adjustable; and remaining paths out of the plurality of paths communicate to the liquid mixing system through opening/closing valves capable of performing opening/closing operation independently.
